(19) United States
(12) Patent Application Publication
(10) Pub. No.: US 2022/0005093 A1
(43) Pub. Date: Jan. 6, 2022

(54) CONTENT MANAGEMENT SYSTEM AND METHOD THEREOF

(71) Applicant: Effectus Partners LLC, Stamford, CT (US)

(72) Inventors: Chetan Shah, Stamford, CT (US); Junior Villegas, Stamford, CT (US); Valeria Izquierdo, Stamford, CT (US); Ashish Garodia, Stamford, CT (US)

(21) Appl. No.: 17/368,372

(22) Filed: Jul. 6, 2021

Related U.S. Application Data
(60) Provisional application No. 63/048,473, filed on Jul. 6, 2020.

(51) Int. Cl. G06Q 30/06

(52) U.S. Cl. CPC G06Q 30/0603; G06Q 30/0633

(57) ABSTRACT

Disclosed is a content management system and a method. The content management system and a method comprise the steps to obtain a product catalog from a plurality of vendors, and generate a second set of data based on an extraction of data from the first set of data using a plurality of rules. In one example, the product catalog comprises a product list manufactured by the vendor, vendor data and a first set of data associated with one or more product from the product list and the second set of data is associated with the one or more product from the product list. Further, the content management system and a method comprise the steps to receive a selection instruction and hierarchy taxonomy associated with the one or more product for the product list and publish the one or more product and, the second set of data associated with the one or more product on one or more of e-commerce platforms, marketplace and websites based on a selection instruction and hierarchy taxonomy.

### CROSS-REFERENCE TO RELATED APPLICATION

This application claims the benefit of U.S. Provisional Application No. US 63/048,473 filed on Jul. 6, 2020, which is incorporated herein by reference in its entirety.

### TECHNICAL FIELD

The present disclosure described herein, in general, relates to content and in particular for managing content to be published on various platform.

### BACKGROUND

Product data includes all types of information about every product a business sells, including manufacturing materials, technical specifications, size and weight, photographs and schematics, and much more. Generally, this data is presented to potential customers help decide to purchase the products, making it crucial to the bottom line. Thus, new or updated product information needs to go to every channel, which includes multiple eCommerce stores, outside sales channels such as Amazon, Facebook, and Google Shopping, and internal channels such as the marketing.

Typically, problem arises when product information needs to be changed or added, especially when there's a large amount of information due to the size of the inventory. Typically, as per the conventional process, entering data for a single product on a single channel is usually easy but updating thousands of products across multiple platforms and keeping them all consistent is a challenge. As inventories grow, it becomes increasingly difficult for existing infrastructures to catalog all the data for each product and publish it on multiple platforms. The problems in handling the data increase multifold if the business is a distributer or sales channel to multiple manufactures and products Additionally, if it takes too long, additional updates may come to light during the process and cause even more confusion.

Generally, conventional systems provide a centralized location for product information, but conventional systems and methods fail to provide an effective solution as conventional systems and methods hard to customize and comes with a significant learning curve. Additionally, conventional systems and methods can't integrate with your ERP and won't be able to publish on multiple platforms simultaneously, with data that is in confirmation with these multiple platforms.

### SUMMARY

Before the present content management system(s) and method(s) are described, it is to be understood that this application is not limited to the particular content management system(s) and methodologies described, as there can be multiple possible embodiments which are not expressly illustrated in the present disclosure. It is also to be understood that the terminology used in the description is for the purpose of describing the particular implementations or versions or embodiments only and is not intended to limit the scope of the present application. This summary is provided to introduce aspects related to a content management system and a method. This summary is not intended to identify essential features of the claimed subject matter nor is it intended for use in determining or limiting the scope of the disclosure.

In one implementation, a content management system, a method and a non-transitory computer readable medium embodying a program executable in a computing device for content management are disclosed.

In one aspect, a content management system is disclosed. In one embodiment the content management system comprises a memory; and at least one processor operatively coupled to the memory, the at least one processor configured to obtain a product catalog from a plurality of vendors, and generate a second set of data based on an extraction of data from the first set of data using a plurality of rules. In one example, the product catalog comprises a product list manufactured by the vendor, vendor data and a first set of data associated with one or more product from the product list and the second set of data is associated with the one or more product from the product list. Further, the at least one processor configured to receive a selection instruction and hierarchy taxonomy associated with the one or more product for the product list and publish the one or more product and, the second set of data associated with the one or more product on one or more of e-commerce platforms, marketplace and websites based on a selection instruction and hierarchy taxonomy.

In one aspect, a method for content management is disclosed. In one embodiment, the method comprises the steps of obtaining a product catalog from a plurality of vendors and, generating a second set of data based on an extraction of data from the first set of data using a plurality of rules. In one example, the product catalog comprises a product list manufactured by the vendor, vendor data and a first set of data associated with one or more product from the product list and the second set of data is associated with the one or more product from the product list Further, the method comprises the steps of receiving a selection instruction and hierarchy taxonomy associated with the one or more product for the product list and publishing the one or more product and, the second set of data associated with the one or more product on one or more of e-commerce platforms, marketplace and websites based on a selection instruction and hierarchy taxonomy.

In yet another embodiment of the present invention, a computer program product is provided. The computer program product comprises a non-transitory computer-readable storage medium which stores a set of instructions. The set of instructions, when executed by a computing device, cause the computing device to perform the operations of obtaining a product catalog from a plurality of vendors and generating a second set of data based on an extraction of data from the first set of data using a plurality of rules. In one example, the product catalog comprises a product list manufactured by the vendor, vendor data and a first set of data associated with one or more product from the product list and second set of data is associated with the one or more product from the product list. Further, the set of instructions, when executed by a computing device, cause the computing device to perform the operations of receiving a selection instruction and hierarchy taxonomy associated with the one or more product for the product list and computing a first score for each of the one or more product from the product list based on analysis of second set of data, with the score indicate of a quality of data corresponding to the product. Furthermore, the set of instructions, when executed by a computing device, cause the computing device to perform the operations of filtering products from the one or more product with the score below a predefined value and publishing, by the processor, the one or more product and, the second set of data associated with the one or more product on one or more of e-commerce platforms, marketplace and websites based on a selection instruction and hierarchy taxonomy.

### BRIEF DESCRIPTION OF THE DRAWINGS

The foregoing detailed description of embodiments is better understood when read in conjunction with the appended drawings. For the purpose of illustrating the disclosure, there is shown in the present document example constructions of the disclosure; however, the disclosure is not limited to the specific methods and apparatus disclosed in the document and the drawings.

The present disclosure is described in detail with reference to the accompanying figures. In the figures, the left-most digit(s) of a reference number identifies the figure in which the reference number first appears. The same numbers are used throughout the drawings to refer various features of the present subject matter.

FIG. 1 illustrates a network implementation of a content management system, in accordance with an embodiment of the present subject matter.

FIG. 2 illustrates the content management system, in accordance with an embodiment of the present disclosure.

FIG. 3 illustrates a method for content management in accordance with an embodiment of the present disclosure.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any content management system and methods, similar or equivalent to those described herein can be used in the practice or testing of embodiments of the present disclosure, the exemplary, content management system and methods are now described. The disclosed embodiments for content management are merely examples of the disclosure, which may be embodied in various forms.

Various modifications to the embodiment will be readily apparent to those skilled in the art and the generic principles herein may be applied to other embodiments. For example, although the present disclosure will be described in the context of a content management system and a method, it will readily recognize that the method and content management system can be utilized in any situation where there is need to provide filtering and ranking of various submission done by vendors during procurement of content. Thus, the present disclosure is not intended to be limited to the embodiments illustrated but is to be accorded the widest scope consistent with the principles and features described herein.

As described in the previous section, business tend to wasting time, money, and manpower—and worse while allowing inaccurate information to persist in absence of an efficient way to send accurate product data to every channel. Further, the inaccuracies caused by outdated information or by the potential for human error that naturally comes with manual data entry results in disappointed customers with feel they've purchased the wrong products and come to the conclusion that they can't trust you. Further, the time and resources needed to put into customer service and returned purchase handling can be overwhelming and expensive, and still don't cover the damage to the brand's reputation.

Typically, the convention system and methods involve manual process of publishing data on multiple channels. For example, the Manual processes are time consuming because they often involve long processes involving online searches, completing paper based or email requests and manually communicating with multiple platforms. When data is input manually mistakes occur more frequently, resulting in errors and inefficiencies. Additionally, Measuring ROI of a campaign is also difficult. Often meaningful data is hard to gather and is kept in individual spreadsheets and email folders scattered across the organization. If information about purchases fed back from customers is hard to gather and incomplete, this means there is no spend visibility or control over the promotional goods expenditure.

In one embodiment of the present subject a content management system and method are disclosed. In the embodiment, a product catalog from a plurality of vendors is obtained and a second set of data is generated based on an extraction of data from the first set of data using a plurality of rules. In one example, the product catalog comprises a product list manufactured by the vendor, vendor data and a first set of data associated with one or more product from the product list and the second set of data is associated with the one or more product from the product list. Further, a selection instruction and hierarchy taxonomy associated with the one or more product for the product list is received and the one or more product and, the second set of data associated with the one or more product are published on one or more of e-commerce platforms, marketplace and websites based on a selection instruction and hierarchy taxonomy.

While aspects of described content management system and method may be implemented in any number of different computing content management systems, environments, and/or configurations, the embodiments are described in the context of the following exemplary content management system.

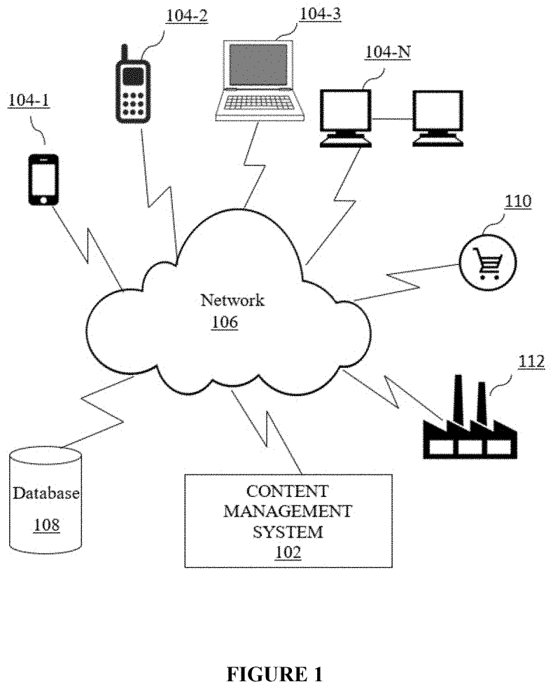

Referring now to FIG. 1, a network implementation 100 of a content management system 102 is disclosed. Although the present disclosure is explained considering that the content management system 102 is implemented on a variety of computing content management systems, such as a laptop computer, a desktop computer, a notebook, a workstation, a mainframe computer, a server, a network server, a cloud-based computing environment and the like. It will be understood that the content management system 102 may be accessed by multiple users through one or more user devices 104-1, 104-2, 104-3, 104-N. In one implementation, the content management system 102 may comprise the cloud-based computing environment in which a user, interchangeably may referred to as a consumer, may operate individual computing content management systems configured to execute remotely located applications. Examples of the user devices 104 may include, but are not limited to, a portable computer, a personal digital assistant, a handheld device, and a workstation. The user devices 104 are communicatively coupled to the content management system 102 and a database 108 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

In the implementation the content management system 102 initially may obtain a product catalog from a plurality of vendors 112. In one example, the product catalog comprises a product list manufactured by the vendor 112, vendor or manufactures data and a first set of data associated with one or more product from the product list. Further the content management system 102 may identify one or more missing data from product catalog and communicate a data request notification to one or more vendors associated with the missing data from plurality of vendors 112. In one case, upon receiving the missing data, the content management system 102 may generate a second set of data based on an extraction of data from the first set of data using a plurality of rules. In one example, the second set of data is associated with the one or more product from the product list. The content management system 102 may identify one or more duplicate images from the second set of data, and the products associated with the duplicate images using image comparison generates a notification for amending the identified duplicate images. Furthermore, the content management system 102 may generate a hierarchy taxonomy based on user instruction and receive a selection instruction associated with one or more products. Upon computing the content management system 102 may compute a first score for each of the one or more product from the product list based on analysis of second set of data. In one example, the score may indicate of a quality of data corresponding to the product. Upon scoring the content management system 102 may filter products from the one or more product with the score below a predefined value. Further to filtering, the content management system 102 may publish the one or more product and, the second set of data associated with the one or more product on one or more of e-commerce platforms, marketplace and websites, jointly referred to as 110, based on a selection instruction and hierarchy taxonomy.

In one embodiment the content management system 102 may obtain a third set of data from the one or more of e-commerce platforms, marketplace and websites and generate on or more recommendation corresponding to the one or more products from the list of products for modification or addition of the second set of data. In one example, the third set of data comprises one or more of buyer feedback, sales data, sales analytics, byer analytics. Upon generating the content management system 102 may compute an updated score for each of the one or more product from the product list based on analysis of second set of data, with the score indicate of a quality of data corresponding to the product.

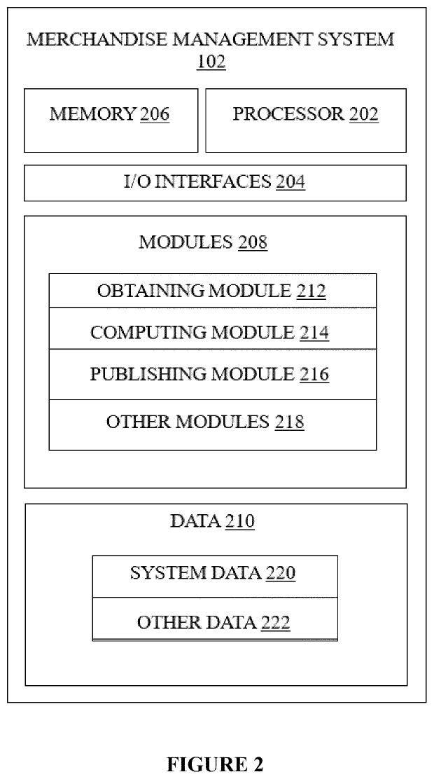

Referring now to FIG. 2, the content management system 102 is illustrated in accordance with an embodiment of the present subject matter. In one embodiment, the content management system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the content management system 102 to interact with the user directly or through the client devices 104. Further, the I/O interface 204 may enable the content management system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory 206 may include or be communicatively coupled to modules 208 and data 210.

The modules 208 include routines, programs, objects, components, data structures, etc., which perform particular tasks or implement particular abstract data types. In one implementation, the modules 208 may include an obtaining module 212, a computing module 214, a publishing module 216 and other modules 218. The other modules 218 may include programs or coded instructions that supplement applications and functions of the content management system 102. The modules 208 described herein may be implemented as software modules that may be executed in the cloud-based computing environment of the content management system 102.

The data 210, amongst other things, serves as a repository for storing data processed, received, and generated by one or more of the modules 208. The data 210 may also include a system data 220, and other data 222. The other data 222 may include data generated as a result of the execution of other modules 218, and system data 220 may include data generated as a result of the execution of the obtaining module 212, the ranking module 214, the ordering module 216 in the other modules 208. The detailed description of the modules 208 along with other components of the content management system 102 is further explained by referring to FIG. 2.

In one implementation, at first, a user may use the user device 104 to access the content management system 102 via the I/O interface 204. The user may register themselves using the I/O interface 204 in order to use the content management system 102. In one aspect, the user may access the I/O interface 204 of the content management system 102 for customizing the content management system 102, preparing various notification templets and data presentation templets. Further, the content management system 102 may employ the obtaining module 212, the computing module 214, the publishing module 216 for effective content management for example in ecommerce domain. The detailed working of the plurality of modules is described below.

In the embodiment, the obtaining module 212 initially may obtain a product catalog from a plurality of vendors 112 such as Samsung, Bose, etc. In one example, the product catalog comprises a product list manufactured by the vendor 112, for example, head phones, speakers, vendor data and a first set of data associated with one or more product from the product list. The first set of data may comprise one or more attributes of the product as shape, size, dimensions, color, manufacturing process etc. Further the obtaining module 212 may identify one or more missing data from product catalog and communicate a data request notification to one or more vendors associated with the missing data from plurality of vendors 112. In the embodiment the obtaining module 212 may store the product catalog and any addition information received in system data 220.

In the embodiment, the computing module 214 may generate a second set of data based on an extraction of data from the first set of data using a plurality of rules. In one example, the second set of data is associated with the one or more product from the product list. In one example, the rules may be predefined by the user or generated based on the selection of publishing platforms. In one example, the user may select the ecommerce platforms, such as Amazon or Facebook market, where the second set of data may be published. Upon receiving the computing module 214 may generate one or more rules specific to the select e-commerce platforms which are executed during extraction the computing module 214. In one example, the rules may be such that for Amazon requires pretax price, while for Facebook market requires total price comprising tax and delivery cost.

In the embodiment, the computing module 214 may further identify one or more duplicate images from the second set of data, and the products associated with the duplicate images using image comparison generates a notification for amending the identified duplicate images. In one example, the computing module 214 may also identify one or more duplicate information and the products associated with the duplicate information. Upon identifying the computing module 214 may compare the products where the duplicate issue exists and identify if they are the same product or different, and generate notification of addition data and confirmation form a user.

In the embodiment subsequently, the computing module 214 may generate a hierarchy taxonomy based on user instruction and receive a selection instruction associated of one or more products. In one example, the hierarchy taxonomy may be understood as organization of products in a store on an ecommerce platforming other words the product categories and subcategories organized in a hierarchical structure. In one example, the hierarchy taxonomy may be generated for each of the e-commerce selected platforms.

In the embodiment, upon generating the computing module 214 compute a score for each of the one or more product from the product list based on analysis of second set of data and a content scoring methodology. In one example, the score may indicate a quality of data corresponding to the product. In one example, the content scoring methodology comprise calculating an element score for a plurality of elements also referred to as attributes of a product, using a predefined score chart. Table 2 illustrates, an example of a predefined score value and associated elements. In one example, the elements or attributes may be size, shape, dimensions, weight, color, warranty, usage, images and the like. Upon calculation, the content scoring methodology comprise calculating weighted item score is calculated by multiplying the element score its weightage obtained from the weightage matrix. Further, the Table 1 illustrates an example of a weightage matrix. Further, the score is computed by summation of the weighted matrix. In one more example, the computing module 214 compute a score for each of the one or more product from the product list based on analysis of second set of data and an equation 1. Further, the computing module 214 may rank each of the products based on the score.

S=(Σ_1\hat{ }n [symbol] [symbol] (X*Y) [symbol] )/n (Equation 1)

### Wherein:

S: is the score of a product

X: is the element score vale of an element

Y: is the weight of the element

N: is the total number of elements

TABLE 1
Weightage Matrix

| Elements | Weight |
|---|---|
| image | 25 |
| dimensions | 10 |
| Packaging | 10 |
| weight | 5 |
| warranty | 5 |
| User manual | 5 |
| Price | 10 |
| Delivery time | 5 |
| Reusable | 10 |
| Sustainability | 15 |

TABLE 2
Element Score Chart

| | | Element |
|---|---|---|
| | | Score |
| Elements | Definition | Value |
| Images | More than 5 | 5 |
| Images | Less than five | 2 |
| Images | missing | −2 |
| Usage | Present | 2 |
| Video | | |
| Usage | Absent | 0 |
| Video | | |
| Reusable | Reusable multiple times | 3 |
| Reusable | One-time Use | 1 |
| Reusable | Reusable multiple times | 3 |
| Reusable | One-time Use | 1 |
| Packaging | Edible Packaging | 5 |
| Packaging | Plant-based | 4 |
| Packaging | Compostable/ | 3 |
| | Bio-degradable | |
| Packaging | Other | — |
| Delivery | Leadtime is 1-2 Weeks OR | 3 |
| time | 2-3 Weeks OR 3-4 Weeks | |
| Delivery | Leadtime is 4-6 Weeks | 2 |
| time | OR 5-7 Weeks | |
| Delivery | Leadtime is 8-10 Weeks | 1 |
| time | OR 10-12 Weeks OR 13-15 | |
| | Weeks OR 16-18 Weeks | |

In the embodiment, subsequently the publishing module 216 may filter products from the one or more product with the score below a predefined value and generate notification for information to increase the score. In one example, the notification may comprise recommendation on the information based on historical insights. For example, notification may be to provide addition images and usage as the historical insight indicate that the sales increase 3 times with 5 or more images and usage video. In one example, the publishing module 216 may provide recommendation for all the products, such as add a color as historical insights indicate returns reduce by 25% if color is mentioned.

Further to filtering, the publishing module 216 may publish the one or more product and, the second set of data associated with the one or more product on one or more of e-commerce platforms, marketplace and websites, jointly referred to as 110, based on a selection instruction and hierarchy taxonomy. In one example, prior to publishing the publishing module 216 may convert the second set of data in to one or more compatible sets corresponding to selected ecommerce platform.

In one embodiment, the publishing module 216 may obtain a third set of data from the one or more of e-commerce platforms, marketplace and websites associated with the published products. In one example, the third set of data may comprise information such as total sale, total returns, number of questions asked by customer, buyer demographics reasons of return and the like associate with one or more products published. Further, the publishing module 216 may generate one or more insights based on the third set of data and store the insights in system data as historical insights. Further, the publishing module 216 may generate on or more recommendation corresponding to the one or more products from the list of products for modification or addition of the second set of data.

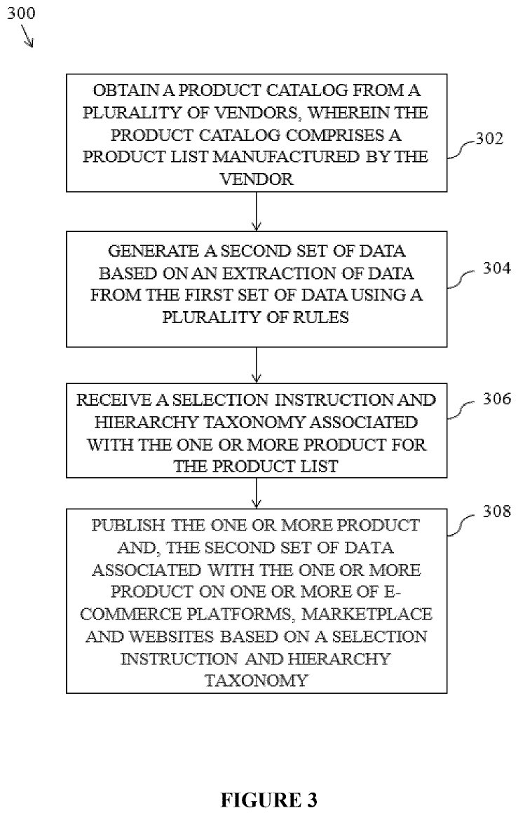

Referring now to FIG. 3, a method 300 for content management is shown, in accordance with an embodiment of the present disclosure. The method 300 may be described in the general context of computer executable instructions. Generally, computer executable instructions can include routines, programs, objects, components, data structures, procedures, modules, functions, etc., that perform particular functions or implement particular abstract data types. The method 300 may be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the disclosure described herein. Furthermore, the method can be implemented in any suitable hardware, software, firmware, or combination thereof. However, for ease of explanation, in the embodiments described below, the method 300 may be considered to be implemented in the above described in the content management system 102.

At block 302, a product catalog from a plurality of vendors is obtained. In one example, the product catalog comprises a product list manufactured by the vendor, vendor data and a first set of data associated with one or more product from the product list. In one implementation, a product catalog from a plurality of vendors may be obtained by the obtaining module 212. Further, the product catalog may be stored in the system data 220 by the obtaining module 212.

At block 304, a second set of data may be generated based on an extraction of data from the first set of data using a plurality of rules. In one example, second set of data is associated with the one or more product from the product list. In one implementation, a second set of data may be generated by the computing module 214. Further, the second set of data may be stored in the system data 220 by the computing module 214.

At block 306 a selection instruction and hierarchy taxonomy associated with the one or more product for the product list is received. In one implementation, a selection instruction and hierarchy taxonomy may be received by the computing module 214. Further, the selection instruction may be stored in the system data 220 by the computing module 214.

At block 308, the one or more product and, the second set of data associated with the one or more product may be published on one or more of e-commerce platforms, marketplace and websites based on a selection instruction and hierarchy taxonomy. In one implementation, the one or more product and, the second set of data associated with the one or more product may be published by the publishing module 216. Further, the publishing information may be stored in the system data 220 by the publishing module 216.

Although implementations for methods and content management systems have been described in language specific to structural features and/or methods, it is to be understood that the appended claims are not necessarily limited to the specific features or methods described. Rather, the specific features and methods are disclosed as examples of implementations of content management.

We claim:

1. A content management system, the content management system comprising:
a memory; and
at least one processor operatively coupled to the memory, the at least one processor configured to
obtain a product catalog from a plurality of vendors, wherein the product catalog comprises a product list manufactured by the vendor, vendor data and a first set of data associated with one or more product from the product list;
generate a second set of data based on an extraction of data from the first set of data using a plurality of rules, wherein second set of data is associated with the one or more product from the product list;
receive a selection instruction and hierarchy taxonomy associated with the one or more product for the product list; and
publish the one or more product and, the second set of data associated with the one or more product on one or more of e-commerce platforms, marketplace and websites based on a selection instruction and hierarchy taxonomy.

2. The content management system as claimed in claim 1, further comprises:
identify one or more missing data from product catalog; and
communicate a data request notification to one or more vendors associated with the missing data from plurality of vendors.

3. The content management system as claimed in claim 2, further comprises generate a hierarchy taxonomy based on user instruction.

4. The content management system as claimed in claim 1, further comprises:
compute a score for each of the one or more product from the product list based on analysis of second set of data, wherein the score indicates a quality of data corresponding to the product; and
filter products from the one or more product with the score below a predefined value.

5. The content management system as claimed in claim 1, further comprises
obtain a third set of data from the one or more of e-commerce platforms, marketplace and websites, wherein the third set of data comprises one or more of buyer feedback, sales data, sales analytics, byer analytics;
generate on or more recommendation corresponding to the one or more products from the list of products for modification or addition of the second set of data; and
compute an updated score for each of the one or more product from the product list based on analysis of second set of data, wherein the score indicates a quality of data corresponding to the product.

6. The content management system as claimed in claim 1, further comprises
identify one or more duplicate images from the second set of data, and the products associated with the duplicate images using image comparison; and
generate a notification for amending the identified duplicate images.

7. A method for content management, the method comprises:
obtaining, by a processor, a product catalog from a plurality of vendors, wherein the product catalog comprises a product list manufactured by the vendor, vendor data and a first set of data associated with one or more product from the product list;
generating, by the processor, a second set of data based on an extraction of data from the first set of data using a plurality of rules, wherein second set of data is associated with the one or more product from the product list;
receiving, by the processor, a selection instruction and hierarchy taxonomy associated with the one or more product for the product list;
publishing, by the processor, the one or more product and, the second set of data associated with the one or more product on one or more of e-commerce platforms, marketplace and websites based on a selection instruction and hierarchy taxonomy.

8. The method as claimed in claim 7, further comprises:
identifying, by the processor, one or more missing data from product catalog; and
communicating, by the processor, a data request notification to one or more vendors associated with the missing data from plurality of vendors.

9. The method as claimed in claim 7, further comprises
generating, by the processor, a hierarchy taxonomy based on user instruction.

10. The method as claimed in claim 7, further comprises:
computing, by the processor, a first score for each of the one or more product from the product list based on analysis of second set of data, with the score indicate of a quality of data corresponding to the product; and
filtering, by the processor, products from the one or more product with the score below a predefined value.

11. The method as claimed in claim 7, further comprises
obtaining, by the processor, a third set of data from the one or more of e-commerce platforms, marketplace and websites, wherein the third set of data comprises one or more of buyer feedback, sales data, sales analytics, byer analytics;
generating, by the processor, on or more recommendation corresponding to the one or more products from the list of products for modification or addition of the second set of data; and
computing, by the processor, an updated score for each of the one or more product from the product list based on analysis of second set of data, with the score indicate of a quality of data corresponding to the product.

12. The method as claimed in claim 7, further comprises
identifying, by the processor, one or more duplicate images from the second set of data, and the products associated with the duplicate images using image comparison; and
generating, by the processor, a notification for amending the identified duplicate images.

13. A computer program product comprises a non-transitory computer-readable storage medium storing a set of instructions, which, when executed by a computing device, cause the computing device to perform the operations of:
obtaining a product catalog from a plurality of vendors, wherein the product catalog comprises a product list manufactured by the vendor, vendor data and a first set of data associated with one or more product from the product list;
generating a second set of data based on an extraction of data from the first set of data using a plurality of rules, wherein second set of data is associated with the one or more product from the product list;
receiving a selection instruction and hierarchy taxonomy associated with the one or more product for the product list;
computing, by the processor, a first score for each of the one or more product from the product list based on analysis of second set of data, with the score indicate of a quality of data corresponding to the product; and
filtering, by the processor, products from the one or more product with the score below a predefined value.
publishing, by the processor, the one or more product and, the second set of data associated with the one or more product on one or more of e-commerce platforms, marketplace and websites based on a selection instruction and hierarchy taxonomy.

14. The computer program product as claimed in claim 13, further comprises:
obtain a third set of data from the one or more of e-commerce platforms, marketplace and websites, wherein the third set of data comprises one or more of buyer feedback, sales data, sales analytics, byer analytics;
generate on or more recommendation corresponding to the one or more products from the list of products for modification or addition of the second set of data; and
compute an updated score for each of the one or more product from the product list based on analysis of second set of data, with the score indicate of a quality of data corresponding to the product.

15. The computer program product as claimed in claim 13, further comprises
identify one or more duplicate images from the second set of data, and the products associated with the duplicate images using image comparison; and
generate a notification for amending the identified duplicate images.
